(19) United States
(12) Patent Application Publication
(10) Pub. No.: US 2014/0274625 A1
(43) Pub. Date: Sep. 18, 2014

(54) TILTING INVERSION EXERCISER HAVING LOCK DEVICE

(71) Applicant: Paul CHEN, (US)

(72) Inventor: Paul CHEN, Vancouver (CA)

(73) Assignee: Paul CHEN, Vancouver (CA)

(21) Appl. No.: 13/802,898

(22) Filed: Mar. 14, 2013

(51) Int. Cl. A61H 1/02

(52) U.S. Cl. CPC A61H 1/0229
USPC 482/144

(57) ABSTRACT

A tilting inversion exerciser includes a supporting stand for supporting a table plate and having two upwardly extended columns, a barrel disposed on an upper portion of one of the columns and having an inclined groove, a supporting table attached to the upper portions of the columns and having an anchoring member attached to a side element, a sleeve rotatably engaged onto the barrel, a latch secured to the sleeve for selectively engaging with the anchoring member, and an actuating member attached to the sleeve and engaged in the inclined groove of the barrel for guiding the sleeve and the latch to move toward and away from the anchoring member by rotating the sleeve relative to the barrel and the column.

### BACKGROUND OF THE INVENTION

1. Field of the Invention

The present invention relates to a tilting inversion exerciser, and more particularly to a tilting inversion exerciser including a catch or latch or lock device or mechanism for selectively catching or latching or locking the supporting table to the supporting stand and for giving some security to the user, and for allowing the users, particularly the elders or disable persons to safely get on and leave the table of the tilting inversion exercisers.

2. Description of the Prior Art

Various kinds of typical inversion suspension exercisers, rotational exercisers, tilting inversion exercisers etc. have been developed and comprise a table rotatably or pivotally attached to an upper portion of a lower or base support or supporting stand with a pivot axle for supporting the user thereon, and rotatable relative to the base support for conducting various inversion or suspension exercises.

For example, U.S. Pat. No. 7,125,372 to Teeter et al., U.S. Pat. No. 7,507,192 to Teeter et al., U.S. Pat. No. 7,585,264 to Wang et al., U.S. Pat. No. 7,625,327 to Teeter et al., and U.S. Pat. No. 7,867,154 to Teeter et al. disclose several of the typical inversion suspension exercisers each comprising a table rotatably or pivotally attached to a base support or supporting stand for supporting the user thereon, and arranged for allowing the users to rotate the table relative to the base support, and to do various inversion or suspension exercises.

However, when the table of the typical inversion suspension exerciser is rotated relative to the base support or supporting stand, the users, particularly the elders or disable persons may feel unsafe and may be afraid that he may have a good chance to fall down to the ground, but the typical inversion suspension exercisers do not have any support devices or catches or latches or lock devices or mechanisms for selectively catching or latching or locking the supporting table to the supporting stand at the required or predetermined positions or locations such that the typical inversion suspension exerciser may not give or provide some security to the user while conducting the inversion exercises.

In addition, the table may not be solidly and stably anchored or secured or retained or secured to the supporting stand at the required or predetermined steady position and may also be swung or pivoted or rotated relative to the lower supporting stand particularly when the elders or disable persons are going to sit or lie or move or get or engage onto the table, or going to leave the table; i.e., the elders or disable persons may feel unsafe.

The present invention has arisen to mitigate and/or obviate the afore-described disadvantages of the conventional tilting inversion exercisers.

### SUMMARY OF THE INVENTION

The primary objective of the present invention is to provide a tilting inversion exerciser including a catch or latch or lock device or mechanism for selectively catching or latching or locking the supporting table to the supporting stand and for giving some security to the user, and for allowing the users, particularly the elders or disable persons to safely get on and leave the table of the tilting inversion exercisers.

In accordance with one aspect of the invention, there is provided a tilting inversion exerciser comprising a supporting stand including a first column and a second column extended upwardly therefrom, the first and the second columns each including an upper portion, a barrel provided on the upper portion of the first column and including an inclined groove formed in the barrel, a supporting table including a first side element and a second side element pivotally attached to the upper portions of the first and the second columns respectively for allowing the supporting table to be pivoted and rotated relative to the supporting stand, and the supporting table including an anchoring member attached to the first side element, and a lock device including a sleeve rotatably engaged onto the barrel of the first column, the sleeve including a chamber formed therein for rotatably receiving and engaging with the barrel and for allowing the sleeve to slide and to rotate relative to the barrel, the lock device including a latch engaged in the chamber of the sleeve and secured to the sleeve for selectively aligning with the anchoring member of the supporting table, and including an actuating member attached to the sleeve and engaged into the chamber of the sleeve and slidably received and engaged in the inclined groove of the barrel for guiding the sleeve and the latch to move toward and away from the anchoring member of the frame when the sleeve is pivoted and rotated relative to the barrel and the first column, and the latch being actuatable to selectively engage with the anchoring member of the supporting table and to selectively secure and retain the supporting table to the supporting stand to a selected angular position when the sleeve is rotated relative to the barrel and the first column in order to actuate and move the actuating member of the sleeve along the inclined groove of the barrel in an active direction, and the latch being actuatable to selectively disengage from the anchoring member of the supporting table and to selectively release the supporting table from the supporting stand when the sleeve is rotated relative to the barrel and the first column in an opposite direction.

The actuating member is engaged with the latch. The sleeve includes a handle attached to the sleeve for rotating the sleeve relative to the barrel and the first column.

The lock device includes a spring biasing member engaged with the latch for biasing and forcing and moving the latch to selectively engage with the anchoring member of the supporting table. The latch includes a peripheral flange extended radially and outwardly therefrom for engaging with the spring biasing member.

The supporting stand includes a stud engaged in the upper portion of the first column and aligned with the anchoring member, the stud includes a bore formed therein, and the latch is slidably received and engaged in the bore of the stud and extendible out of the stud and the first column for selectively engaging with the anchoring member of the supporting table.

The spring biasing member is engaged between the stud of the first column and the latch for biasing and forcing and moving the latch out of the stud and the first column in order to engage with the anchoring member of the supporting table.

The supporting table includes a frame having the first and the second side elements pivotally attached to the upper portions of the first and the second columns respectively with a pivot axle, and a table plate secured and supported on the frame.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a front perspective view of a tilting inversion exerciser in accordance with the present invention;

FIG. 2 is an enlarged partial exploded view of the tilting inversion exerciser as seen from the front portion of the tilting inversion exerciser;

FIG. 3 is another enlarged partial exploded view of the tilting inversion exerciser as seen from the rear portion of the tilting inversion exerciser;

FIG. 4 is a partial cross sectional view of the tilting inversion exerciser, taken along lines 4-4 of FIG. 1;

FIG. 5 is another partial cross sectional view similar to FIG. 4, illustrating the operation of the tilting inversion exerciser; and

FIGS. 6 and 7 are partial top plan schematic views illustrating the operation of the tilting inversion exerciser.

### DETAILED DESCRIPTION OF THE PREFERRED EMBODIMENT

Referring to the drawings, and initially to FIGS. 1-4, a tilting inversion exerciser in accordance with the present invention comprises a lower supporting stand 10 for pivotally or rotatably supporting a base or table 2 thereon, and for supporting a user on the supporting table 2, for example, the lower supporting stand 10 includes two rods or posts or columns 11 extended upwardly therefrom and preferably parallel to each other, and the columns 11 each include an upper portion 12 for pivotally or rotatably supporting or engaging with the supporting table 2. For example, the supporting table 2 includes a lower frame 20, such as a U-shaped frame 20 for attaching or mounting or securing or supporting a table plate 21 thereon and for supporting the user on the table plate 21.

For example, the frame 20 includes two end or side portions or segments or elements 22 each pivotally or rotatably attached or mounted or secured to the upper portion 12 of the respective column 11 with a pivot axle 23 for allowing the table plate 21 and the frame 20 of the supporting table 2 to be pivoted or rotated relative to the supporting stand 10 to any suitable or selected or predetermined angular positions or locations, and the frame 20 further includes a stud or stop or catch or latch or lock or tube or anchoring member 24 attached or mounted or secured to or provided on or extended from either of the side elements 22 or the first side element 22, best shown in FIGS. 4 and 5, and pivoted or rotated in concert with the side element 22 of the frame 20 relative to the column 11 of the supporting stand 10 respectively.

The supporting stand 10 further includes a cylindrical member or barrel or tube or conduit or stud 14 laterally disposed or attached or mounted or secured or engaged in the upper portion 12 of either the left column 11 or the right column 11 or the first column 11, also best shown in FIGS. 4 and 5, and parallel to the pivot axle 23 and/or the side elements 22 of the frame 20 and aligned with the anchoring member 24, and further includes a tube or conduit or stud or cylindrical member or barrel 15 also laterally disposed or attached or mounted or secured to or extended from the upper portion 12 of either the left column 11 or the right column 11 and aligned with the stud 14 and concentric with the stud 14, and also aligned with the anchoring member 24 for attaching or mounting or securing or supporting or engaging with the catch or latch or lock mechanism or device 3 or the like. The barrel 15 includes a helical or tilted or inclined slot or groove 16 formed therein (FIGS. 3-7).

For example, the lock device 3 includes a conduit or cylindrical member or barrel or sleeve 30 pivotally or rotatably attached or mounted or secured to or engaged onto the barrel 15 of the column 11 of the supporting stand 10, for example, the sleeve 30 includes a bore or chamber 31 formed therein for pivotally or rotatably receiving or engaging with the barrel 15 and for allowing the sleeve 30 to slide and move and pivot or rotate relative to the barrel 15, best shown in FIGS. 4-7. The lock device 3 includes a tongue or lock extension or catch or latch 32 disposed or engaged in the chamber 31 of the sleeve 30 and attached or mounted or secured to the sleeve 30 with latches or fasteners 33, and the latch 32 is slidably received or engaged in the bore 17 of the stud 14 (FIGS. 4-5) and extendible out of the stud 14 and the column 11 for selectively aligning with the anchoring member 24 and for selectively engaging with (FIG. 5) of disengaging from (FIG. 4) the anchoring member 24 of the frame 20.

A spring biasing member 34 is disposed or attached or mounted or secured or engaged onto the latch 32 and engaged in the bore 17 of the stud 14 and disposed or contacted or engaged between the stud 14 of the column 11 and the latch 32 for biasing and forcing or moving the latch 32 out of the stud 14 and the column 11 in order to selectively engage with the anchoring member 24 of the frame 20, and thus for selectively attaching or mounting or securing or retaining or positioning or anchoring the table plate 21 and the frame 20 of the supporting table 2 to the supporting stand 10 to any suitable or selected or predetermined angular positions or locations, the latch 32 may include a peripheral flange 35 extended radially and outwardly therefrom for selectively engaging with the spring biasing member 34.

The lock device 3 further includes an anchoring member or lock or tube or latch or stud or stop or catch or follower or actuating member 36 (FIGS. 2-7) attached or mounted or secured to the sleeve 30 and engaged into the chamber 31 of the sleeve 30 and/or optionally attached or mounted or secured to or engaged into or with the latch 32, best shown in FIGS. 4, 5, and the actuating member 36 is slidably received or engaged in the helical or tilted or inclined slot or groove 16 of the barrel 15 for guiding the sleeve 30 and the latch 32 to move toward or away from the anchoring member 24 of the frame 20 when the sleeve 30 is pivoted or rotated relative to the barrel 15 and the stud 14 and the column 11, and the lock device 3 includes a handle 37 attached or mounted or secured to or extended from the sleeve 30 for pivoting or rotating the sleeve 30 relative to the barrel 15 and the stud 14 and the column 11.

In operation, as shown in FIGS. 4-7, when the sleeve 30 is pivoted or rotated relative to the barrel 15 and the stud 14 and the column 11 in order to actuate or operate or move the actuating member 36 of the sleeve 30 along the inclined groove 16 of the barrel 15, in an active direction from one end to the other end of the inclined groove 16 of the barrel 15 (FIGS. 6, 7), the latch 32 may be actuated or operated or moved to selectively engage into or with the anchoring member 24 of the frame 20 (FIG. 5), and in order to selectively attach or mount or secure or retain or position or anchor the table plate 21 and the frame 20 of the supporting table 2 to the supporting stand 10 to any suitable or selected or predetermined angular positions or locations, the barrel 15 may be arranged to solidly and stably anchor or secure or retain the actuating member 36 of the sleeve 30 at either of the ends of the inclined groove 16 of the barrel 15.

When the table plate 21 and the frame 20 of the supporting table 2 are attached or mounted or secured or retained or positioned or anchored to the supporting stand 10 to a selected or predetermined angular position or location, the users, particularly the elders or disable persons may safely get on and leave the table plate 21 of the supporting table 2 without feeling afraid. The latch 32 may be selectively moved away from the anchoring member 24 of the frame 20 by pivoting or rotating the sleeve 30 relative to the barrel 15 and the stud 14 and the column 11 in the other or opposite direction.

Accordingly, the tilting inversion exerciser in accordance with the present invention includes a catch or latch or lock device or mechanism for selectively catching or latching or locking the supporting table to the supporting stand and for giving some security to the user, and for allowing the users, particularly the elders or disable persons to safely get on and leave the table of the tilting inversion exercisers.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tilting inversion exerciser comprising:
a supporting stand including a first column and a second column extended upwardly therefrom, said first and said second columns each including an upper portion,
a barrel provided on said upper portion of said first column and including an inclined groove formed in said barrel,
a supporting table including a first side element and a second side element pivotally attached to said upper portions of said first and said second columns respectively for allowing said supporting table to be pivoted and rotated relative to said supporting stand, and said supporting table including an anchoring member attached to said first side element, and
a lock device including a sleeve rotatably engaged onto said barrel of said first column, said sleeve including a chamber formed therein for rotatably receiving and engaging with said barrel and for allowing said sleeve to slide and to rotate relative to said barrel, said lock device including a latch engaged in said chamber of said sleeve and secured to said sleeve for selectively aligning with said anchoring member of said supporting table, and including an actuating member attached to said sleeve and engaged into said chamber of said sleeve and slidably received and engaged in said inclined groove of said barrel for guiding said sleeve and said latch to move toward and away from said anchoring member of said frame when said sleeve is pivoted and rotated relative to said barrel and said first column, and
said latch being actuatable to selectively engage with said anchoring member of said supporting table and to selectively secure and retain said supporting table to said supporting stand to a selected angular position when said sleeve is rotated relative to said barrel and said first column in order to actuate and move said actuating member of said sleeve along said inclined groove of said barrel in an active direction, and said latch being actuatable to selectively disengage from said anchoring member of said supporting table and to selectively release said supporting table from said supporting stand when said sleeve is rotated relative to said barrel and said first column in an opposite direction.

2. The tilting inversion exerciser as claimed in claim 1, wherein said actuating member is engaged with said latch.

3. The tilting inversion exerciser as claimed in claim 1, wherein said sleeve includes a handle attached to said sleeve for rotating said sleeve relative to said barrel and said first column.

4. The tilting inversion exerciser as claimed in claim 1, wherein said lock device includes a spring biasing member engaged with said latch for biasing and forcing and moving said latch to selectively engage with said anchoring member of said supporting table.

5. The tilting inversion exerciser as claimed in claim 4, wherein said latch includes a peripheral flange extended radially and outwardly therefrom for engaging with said spring biasing member.

6. The tilting inversion exerciser as claimed in claim 4, wherein said supporting stand includes a stud engaged in said upper portion of said first column and aligned with said anchoring member, said stud includes a bore formed therein, and said latch is slidably received and engaged in said bore of said stud and extendible out of said stud and said first column for selectively engaging with said anchoring member of said supporting table.

7. The tilting inversion exerciser as claimed in claim 6, wherein said spring biasing member is engaged between said stud of said first column and said latch for biasing and forcing and moving said latch out of said stud and said first column in order to engage with said anchoring member of said supporting table.

8. The tilting inversion exerciser as claimed in claim 1, wherein said supporting table includes a frame having said first and said second side elements pivotally attached to said upper portions of said first and said second columns respectively with a pivot axle, and a table plate secured and supported on said frame.
